(19) United States
(12) Patent Application Publication
(10) Pub. No.: US 2010/0138157 A1
(43) Pub. Date: Jun. 3, 2010

(54) METHOD FOR PROCESSING BOREHOLE LOGS TO ENHANCE THE CONTINUITY OF PHYSICAL PROPERTY MEASUREMENTS OF A SUBSURFACE REGION

(75) Inventors: Boqin Sun, Concord, CA (US); Keh-Jim Dunn, Fullerton, CA (US)

Correspondence Address: CHEVRON CORPORATION, P.O. BOX 6006, SAN RAMON, CA, 94583-0806, US

(73) Assignee: Chevron U.S.A. Inc.

(21) Appl. No.: 12/325,639

(22) Filed: Dec. 1, 2008

(51) Int. Cl. G01V 3/32; G06F 19/00

(52) U.S. Cl. 702/6

(57) ABSTRACT

A computer-implemented method and system for processing subsurface logs to enhance the continuity of physical property measurements. The method includes obtaining a set of measurement signals along a spatial or time domain from at least one sensor tool moving through a borehole which has traversed through a subsurface region. The method additionally includes performing a global inversion of the set of measurement signals along the spatial or time domain to determine a set of physical properties of the subsurface region having a smooth variation along the spatial or time domain, wherein the set of physical properties can be utilized to determine characteristics of the subsurface region.

### BACKGROUND OF THE INVENTION

This invention generally relates to well logging utilized in hydrocarbon exploration, and more specifically to well log data processing for enhancing the continuity of physical measurements along the depth or time domain which can be utilized to determine the different facies through which a borehole has traversed or characteristics of such facies.

Often times, when carrying out physical measurements, each measurement is treated as an independent event and those independent events are rarely considered in relation to the preceding or subsequent events. However, there are certain cases in which such sequential measurements may be describing the temporal behavior or spatial variation of a physical property of a physical object. In such a situation, one would expect that there should be a certain relation or constraint among sequential data to reflect the smooth variation, either temporal or spatial, of the physical property of the object being measured. One such situation exists in well logging data in the petroleum industry.

When an instrument is lowered into a drilled well to perform measurements of the physical properties of the earth formation, one would expect the measured results to reflect the smooth variation of the physical properties of the earth formation. Even for the transition between layers of different physical characteristics, such as going from sandstone to silty clay, one would expect the transition of the measured physical properties to be reasonably steep yet smooth, not the jittery or oscillatory characteristic which is typical of noise. When the physical measurements properly reflect the earth layers being measured, one can identify them as such and correlate them with those measured at neighboring wells. Such identification and correlation are extremely important in building up a correct reservoir model for efficient hydrocarbon production and reservoir management. However, the oscillatory noise in the measured data often prevents the effective use of well log data for such a purpose, creating a need for a smoothing constraint to improve the correlation of measured well log data to the variations of the “real-world” physical properties of the earth formation. Thus, constraining the solution of measured physical properties of well log data is an important task. Development of such methodology has impact on not only the handling of well log data, but also the treatment of general sequential measurements where constraints on neighboring data sets are required.

### SUMMARY OF THE INVENTION

The present invention overcomes the above-described and other shortcomings of the prior art by providing a method to enhance the continuity of physical property measurements in subsurface logging and processing of well log data for boreholes. In general, the present invention utilizes a vertical constraint along the depth direction of a well, and solves for the physical property of the earth formation with such a constraint. The present invention provides a smooth variation of the physical property, along the depth, which then allows the physical property to be used as a rock type indicator.

It can be appreciated by one skilled in the art that the present invention can also be utilized with data that is sequentially measured such as the time domain, for example Logging While Drilling (LWD) or Measurement While Drilling (MWD).

One embodiment of the present invention includes a computer-implemented method of processing sequential measurements or data of a subsurface region to enhance the continuity of physical property measurements. The method includes obtaining a set of sequential measurements signals along at least one of a spatial or time domain from at least one sensor tool, wherein the sensor tool has obtained the set of sequential measurement signals from the subsurface region. The method further includes performing a global inversion of the set of sequential measurement signals with a smoothness constraint in at least one of the spatial or time domain to determine a set of physical properties of the subsurface region, wherein the set of physical properties has a smooth variation in at least one of the spatial or time domain which can be utilized to determine characteristics of the subsurface region.

It can be appreciated that embodiments of the present invention includes a sensor tool which has obtained the set of sequential measurement signals while moving through a borehole which has traversed through a subsurface region.

The global inversion of another embodiment of the present invention additionally includes transforming the set of sequential measurement signals along the depth domain into a set of pseudo measurement signals along the depth domain, inverting the set of pseudo measurement signals to a set of pseudo physical properties along the depth domain, and transforming the set of pseudo physical properties to the set of physical properties having continuation along the depth domain.

A further embodiment of the present invention includes transforming the set of sequential measurement signals along the depth domain into the set of pseudo measurement signals along the depth domain and transforming the set of pseudo physical properties into the set of physical properties having continuation along the depth domain utilizing B-spline functions, Gaussian functions, Γ functions, or any other functions having similar geometric shape.

A further embodiment of the present invention includes the set of physical properties which can be utilized to determine different facies of the subsurface region through which the borehole has traversed or characteristics of such facies.

A further embodiment of the present invention has the set of sequential measurement signals including Nuclear Magnetic Resonance (NMR) signals.

A further embodiment of the present inventions has the NMR signals induced by application of a set of Radio Frequency (RF) pulses.

A further embodiment of the present invention has the NMR signals including multiple echo trains induced by applying a set of Carr-Purcell-Meiboom-Gill (CPMG) pulse sequences with different echo spacings, wait times, number of echoes, and carrying frequencies.

A further embodiment of the present invention utilizes inversion methods of NMR signals which include single value decomposition or the Butler-Reeds-Dawson (BRD) algorithm, fluid component decomposition (FCD), which are used to generate T₂ distributions, diffusion-T₂ 2D distribution, T₁-T₂ 2D distribution, and/or T₁-T₂-diffusion 3D NMR distributions.

It should also be appreciated by one skilled in the art that the present invention is intended to be used with a system which includes, in general, an electronic configuration including at least one processor, at least one memory device for storing program code or other data, a video monitor or other display device (i.e., a liquid crystal display) and at least one input device. The processor is preferably a microprocessor or microcontroller-based platform which is capable of displaying images and processing complex mathematical algorithms. The memory device can include random access memory (RAM) for storing event or other data generated or used during a particular process associated with the present invention. The memory device can also include read only memory (ROM) for storing the program code for the controls and processes of the present invention.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various Figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

These and other objects, features and advantages of the present invention will become better understood with regard to the following description, pending claims and accompanying drawings where:

FIG. 1 illustrates a flow chart of one embodiment of the present invention;

FIG. 2 illustrates the T₂ inversion of a prior art method and the T₂ inversion of one embodiment of the present invention;

FIG. 3 illustrates the porosities as functions of depth using a prior art inversion method and the T₂ inversion of one embodiment of the present invention;

FIG. 4 illustrates a representation of the global inversion of one embodiment of the present invention;

FIG. 5 is a schematic illustration of an embodiment of a system for performing methods in accordance with one or more embodiments of the invention.

### DETAILED DESCRIPTION OF THE INVENTION

While this invention is susceptible to embodiments in many different forms, there are shown in the drawings, and will herein be described in detail, preferred embodiments of the invention with the understanding that the present disclosure is to be considered as an exemplification of the principles of the invention and is not intended to limit the broad aspect of the invention to the embodiments illustrated.

In general, the present invention includes a method which places a constraint among a neighboring data set to ensure a smooth solution of the measured physical property.

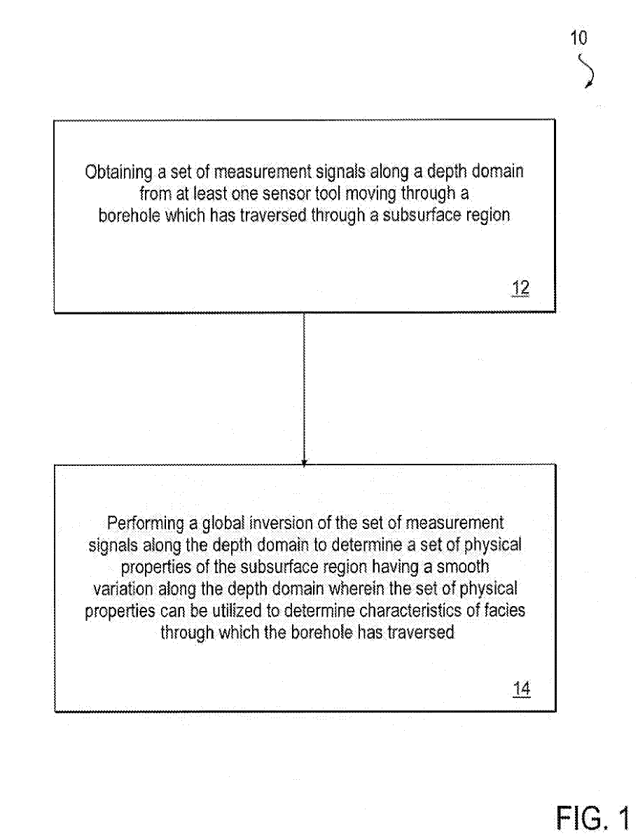

One embodiment of the present invention is illustrated in FIG. 1 which includes a workflow 10 for processing subsurface data to enhance the continuity of physical property measurements. That embodiment includes obtaining a set of measurement signals along a depth domain from at least one sensor tool moving through borehole which has traversed through subsurface region 12. The embodiment further includes performing a global inversion of the set of measurement signals along the depth domain to determine a set of physical properties of the subsurface region having a smooth variation along the dept domain, wherein the set of physical properties can be utilized to determine characteristics of facies through which the borehole has traversed 14.

As one in the art will appreciate, modern petroleum drilling utilizes different tools to log subsurface formations through which the borehole has traversed. One such tool utilizes NMR to log wells or boreholes. Before a subsurface formation is logged with an NMR tool, the protons in the formation fluids are randomly oriented. When the tool passes through the formation, the tool generates magnetic fields that activate those protons. First, the tool's permanent magnetic field aligns, or polarizes, the spin axes of the protons in a particular direction. Then the tool's oscillating field is applied to tip these protons away from their new equilibrium position. When the oscillating field is subsequently removed, the protons begin tipping back, or relaxing, toward the original direction in which the static magnetic field aligned them. Specified pulse sequences are used to generate a series of so-called spin echoes, which are measured by the NMR logging tool and are displayed on logs as spin-echo trains. These spin-echo trains constitute the raw NMR data.

The amplitude of the spin-echo-train decay can be fit very well by a sum of decaying exponentials, each with a different decay constant. The set of all the decay constants forms the decay spectrum or transverse-relaxation-time (T₂) distribution. T₂ distributions can be utilized to determine characteristics of various subsurface formations. For example, in water-saturated rocks, it can be proven mathematically that the decay curve associated with a single pore will be a single exponential with a decay constant proportional to pore size; that is, small pores have small T₂ values and large pores have large T₂ values. At any depth in the wellbore, the rock samples probed by the NMR tool will have a distribution of pore sizes. Thus, the multi-exponential decay represents the distribution of pore sizes at that depth, with each T₂ value corresponding to a different pore size. One characteristic a T₂ distribution can determine is porosity. T₂ distributions may also be used to determine the different rock or facies types through which a borehole has traversed. However, the spurious signals in NMR logging often result in neighboring depth intervals of the same rock type to have dissimilar T₂ distributions and oscillatory porosity responses. This can be due to the noise of the initial echoes which play an important role in determining the porosity values and the shape of a T₂ distribution. As a result, the short T₂ components are not stable and can vary even for the same rock type, preventing the use of T₂ distributions as a rock type (or facies) indicator.

When one embodiment of the present invention is used with T₂ distributions of NMR logs used in oil exploration, the fluctuations of both porosity and shape of T₂ distribution for sequential depth intervals are reduced. It can be appreciated by one skilled in the art that the present invention may be extended to other types of sequential measurements where constraint of smoothness among neighboring data set is required. Two such examples are scalar and 2D/3D NMR Logs.

In an NMR logging measurement, T₂ echo trains are acquired which can be written as follows:

$${b}_{i} = {\sum }_{j = 1}^{m} {f}_{j} {e}^{- {t}_{i} / {T}_{j}} + {ɛ}_{i} = {\sum }_{j = 1}^{m} {K}_{ij} {f}_{j} + {ɛ}_{i} ( i = 1 … n ) , \qquad ( 1 )$$

where bᵢ is the measured signal of the i-th echo in a train of n echoes with a noise of εᵢ at a decay time tᵢ, and fᵢ is the amplitude to be solved for the j-th T₂ relaxation time for a set of m preselected T₂'s equally spaced on a logarithmic scale. In general, the problem is solved using various prior art regularization methods to ensure the smooth behavior of T₂ distribution. One of the methods often used is the basis function approach in which the amplitude f is expressed as the sum of smooth basis functions such as B-spline functions. Thus, at each depth, there is:

bᵢ=Kᵢⱼfⱼ=KᵢⱼBⱼₛCₛ=GᵢₛCₛ (2)

where repeated indices represent summation, and bᵢ is the echo train of the i-th depth, Kᵢⱼ is the kernel of the T₂ inversion problem, Bⱼₛ is the basis function in discretized form, and Cₛ becomes the new amplitudes to be solved. Here, the matrix product KᵢⱼBⱼₛ is replaced with Gᵢₛ to simplify the appearance.

The above-described method handles the echo train obtained at each depth separately. Thus, the T₂ distribution at each depth interval may be smooth but the spurious noise would still cause the T₂ distributions of the neighboring depth intervals to be erratic and dissimilar even though they may be of the same rock type or facies. This embodiment of the present invention utilizes a constraint along the depth direction to ensure smooth variation of T₂ distributions for neighboring depth intervals. One embodiment of the present invention uses the same basis function approach, but now, in the direction of the depth. The whole T₂ log as a function of depth can be cast into one single matrix problem as:

b_{iλ}=GᵢₛC_{sλ} (3)

where b_{iλ} and C_{sλ} are matrices, and each column of b_{iλ} represents the echo train obtained at the λ-th depth interval, with the corresponding column in C_{sλ} representing the solution at that depth interval. To constrain the behavior of the s-th component of C_{sλ} among various λ values, i.e., various depth intervals, using the basis function approach, the transpose of C_{sλ} can be written as:

C_{λs}=H_{λμ}A_{μs}, (4)

where H_{λμ} is another set of selected basis functions for smoothing the behavior of C_{sμ}, along the depth direction with μ as the index for the basis functions and μ as the index for the discretized values of the basis functions, and A_{μs} are the new solution matrices that are being solved for. Substituting Eq. (4) into Eq. (3) results in:

b_{iλ}=GᵢₛA_{sμ}H_{μλ}, (5)

where A_{sμ} and H_{μλ} are the transpose of A_{μs} and H_{λμ}, respectively. To have a solvable form, A_{sμ} is placed in the right most position as C_{sλ} in Eq. (3). To achieve this, both sides of Eq. (5) are first multiplied by the transpose of H_{μλ}, converting it to a square symmetric matrix Q_{μμ}:

b_{iλ}H_{λμ}=GᵢₛA_{sμ}H_{μλ}H_{λμ}=GᵢₛA_{sμ}Q_{μμ} (6)

and both side of the Eq. (6) are then multiplied by the inverse of Q_{μμ} resulting in:

b_{iλ}H_{λμ}(Q_{μμ})⁻¹=GᵢₛA_{sμ}. (7)

Equation (7) can be solved to obtain the solution matrices A_{sμ}.

Eq. (7) describes a general data transformation method from depth domain (indicated by the index λ) to a pseudo depth domain (indicated by the index μ). The actual inversion is performed in the pseudo depth domain and the back transformation (given by Eq. (4)) gives continuous results in the original depth domain.

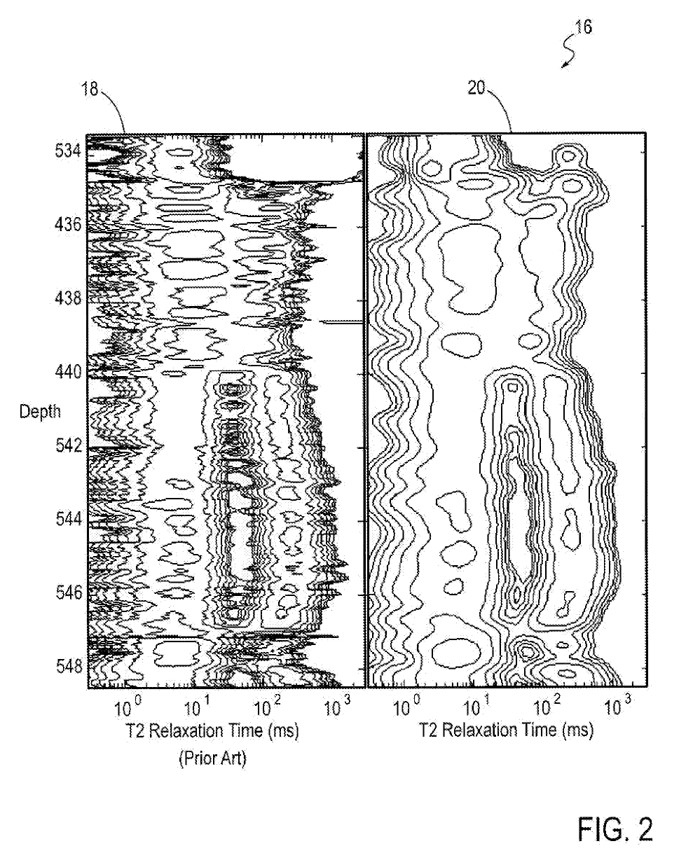

FIG. 2 illustrates one embodiment of the present invention showing the result of one log example 16, where the left panel 18 shows the result of regular T₂ inversion using Eq. (2) with cubic B-spline as the basis function only along T₂ relaxation axis at each depth. The right panel 20 in FIG. 2 shows the result of T₂ inversion using Eq. (7) with cubic B-spline as the basis function set used along the relaxation time axis as well as along the depth direction. There are 150 cubic B-spline functions in depth domain for 328 depth values. Both Eqs. (2) and (7) use the single value decomposition algorithm. The spurious variations of the prior art T₂ distributions that are present in the left panel 18 among neighboring depths, especially at both sides of the T₂ peaks along the relaxation time axis, are not present in the vertically constrained T₂ distributions 20. Note that depth direction is often called vertical direction because of the standard format of log display used in the oil industry.

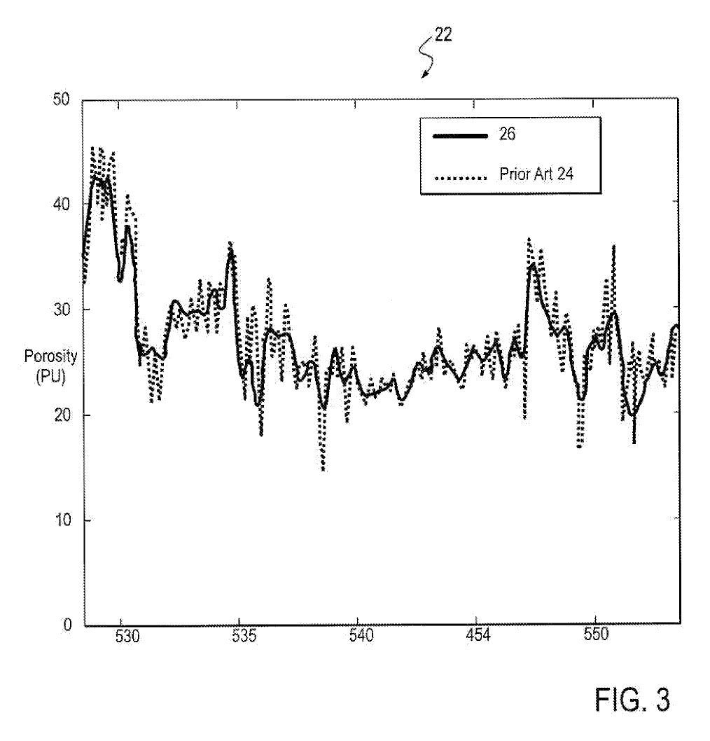

FIG. 3 illustrates a comparison of porosities 22 as functions of depth using prior art inversion for each depth 24 and constrained inversion along the depth domain 26 in one embodiment of the present inversion. The prior art inversion 24 includes significant oscillations whereas the constrained inversion along the depth domain 26 includes a steady variation.

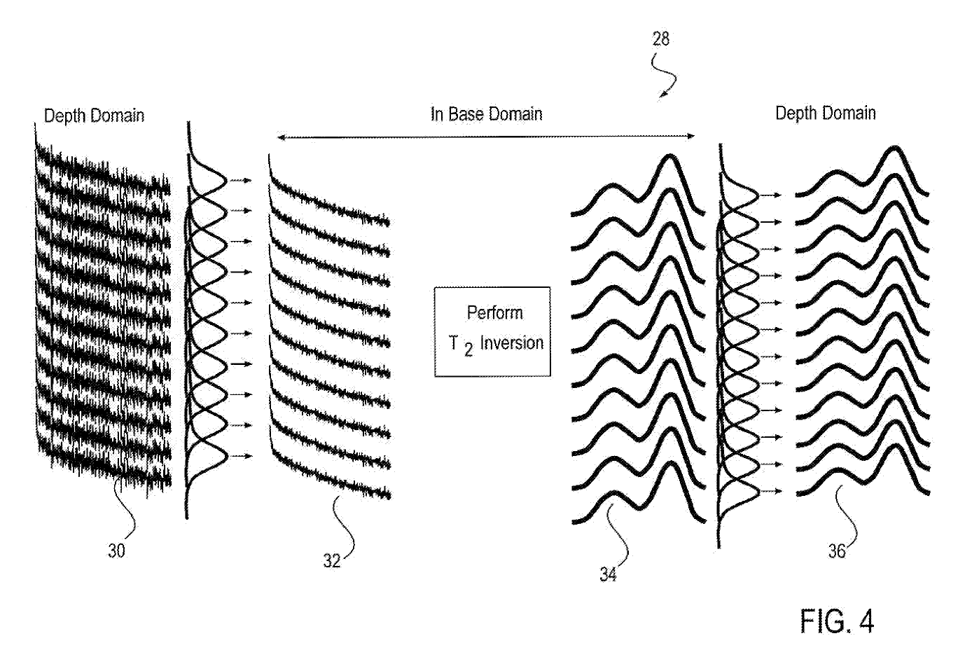

In one embodiment of the present invention, the global inversion includes transforming the set of sequential measurement signals along the depth domain into a set of pseudo measurement signals along the depth domain, inverting the set of pseudo measurement signals to a set of pseudo physical properties along the depth domain, and transforming the set of pseudo physical properties to the set of physical properties having continuation along the depth domain. Utilizing T₂ distributions, one example 28 of this embodiment is illustrated in FIG. 4. Raw Echoes along the depth domain 30 are transformed into a set of pseudo transformed echoes along the depth domain 32. The set of pseudo transformed echoes along the depth domain 32 is then inverted into a set of pseudo T₂ distributions along the depth domain 34. The set of pseudo T₂ distributions along the depth domain 34 is then transformed into a set of T₂ distributions with vertical continuation or having smooth variation along the depth domain 36.

As can be appreciated by one skilled in the art, the present invention utilizing vertical constraint along the depth direction can be used to regularize T₂ or T₁ inversion. It can also be used to perform vertical constraint for scalar log data or 2D and 3D NMR data such as D/T₂, T₁-T₂ 2DNMR.

One embodiment of the present invention includes a vertical constraint for scalar logs. If the log is a scalar which has a single value for each depth interval, the value is denoted as b_{λ}. Then the vertical constraint problem can be formulated as:

b_{λ}=H_{λμ}a_{μ} (8)

where H_{λμ} is a set of selected basis functions for smoothing the behavior of b_{λ} along the depth direction with μ as the index for the basis functions and λ as the index for the discretized values of the basis functions and a_{μ} is the smoothed scalar solution which is being solved for.

Another embodiment of the present invention includes a vertical constraint for 2D or 3D-NMR Logs. If the log is a 2D NMR data, the problem for each depth interval can be written as for this particular embodiment:

bᵢₖ=K_{ik,jh}fⱼₕ (9)

where bᵢₖ is the data for each depth record, K_{ik,jh} is the 2D kernel, and fⱼₕ is the 2D solution for each depth. To implement the vertical constraint, it is assumed that the variation of the 2D variables along the depth direction can be described by a single set of basis functions H_{λμ} as the following:

b_{ik,λ}=K_{ik,jh}f_{jh,λ}=K_{ik,jh}A_{jh,μ}H_{μλ} (10)

where:

f_{λ,jh}=H_{λμ}A_{μ,js} (11)

and A_{jh,μ} is the new 2D solution to be solved. Again, multiplying both sides of Eq. (10) by H_{λμ} and the inverse of Q_{μμ}, the result is:

b_{ik,λ}H_80 μ(Q_{μμ})⁻¹=b′_{ik,μ}=K_{ik,jh}A_{jh,μ} (12)

Now, A_{jh,μ} can be solved.

If the log is a 3D NMR data, the problem for each depth interval can be described as for this particular embodiment:

bᵢₖ=K_{ik,jhl}fⱼₕₗ (13)

where bᵢₖ is the data for each depth record, K_{ik,jhl} is the 3D kernel, and fⱼₕₗ is the 3D solution for each depth. To implement the vertical constraint, it can be assumed that the variation of the 3D variables along the depth direction can be described by a single set of basis functions H_{λμ} as the following:

b_{ik,λ}=K_{ik,jhl}f_{jhl,λ}=K_{ik,jhl}A_{jhl,μ}H_{μλ} (14)

where:

f_{λ,jhl}=H_{λμ}A_{μ,jhl} (15)

and A_{jhl,μ} is the new 3D solution to be solved. Multiplying both sides of Eq. (14) by H_{λμ} and the inverse of Q_{μμ} results in:

b_{ik,λ}H_{λμ}(Q_{μμ})⁻¹=b′_{ik,μ}=K_{ik,jhl}A_{jhl,μ} (16)

Now, A_{jhl,μ} can be solved.

As one skilled in the art can appreciate, the present invention can be used in type of data where a smoothness constraint among neighboring data set is required, one example would be data in the time domain.

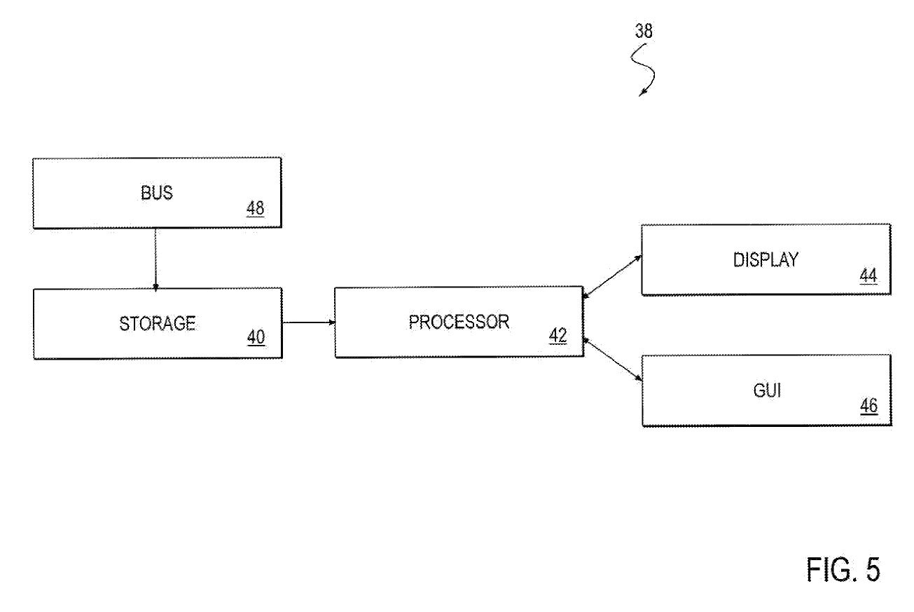

An example of a system for performing the present invention is schematically illustrated in FIG. 5. A system 38 includes a data storage device or memory 40. The stored data may be made available to a processor 42, such as a programmable general purpose computer. The processor 42 may include interface components such as a display 44 and a graphical user interface (GUI) 46. The GUI 46 may be used both to display data and processed data products and to allow the user to select among options for implementing aspects of the method. Data may be transferred to the system 38 via a bus 48 either directly from a data acquisition device, or from an intermediate storage or processing facility (not shown).

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, though reference is made herein to a computer, this may include a general purpose computer, a purpose-built computer, an ASIC programmed to execute the methods, a computer array or network, or other appropriate computing device. As a further example, it is to be understood that the present invention contemplates that, to the extent possible, one or more features of any embodiment can be combined with one or more features of any other embodiment.

What is claimed is:

1. A computer-implemented method of processing sequential measurement signals of a subsurface region to enhance the continuity of physical property measurements, wherein the method comprises:
obtaining a set of sequential measurement signals along at least one of a spatial or time domain from at least one sensor tool, wherein the sensor tool has obtained the set of sequential measurement signals from the subsurface region; and
performing a global inversion of the set of sequential measurement signals with a smoothness constraint in at least one of the spatial or time domain to determine a set of physical properties of the subsurface region, wherein the set of physical properties has a smooth variation in at least one of the spatial or time domain which can be utilized to determine characteristics of the subsurface region.

2. The method of claim 1, wherein the sensor tool has obtained the set of sequential measurements signals while moving through a borehole which has traversed through the subsurface region.

3. The method of claim 1, wherein performing the global inversion of the set of sequential measurement signals includes transforming the set of sequential measurement signals along the depth domain into a set of pseudo measurement signals along the depth domain, inverting the set of pseudo measurement signals to a set of pseudo physical properties along the depth domain, and transforming the set of pseudo physical properties into the set of physical properties having continuation along the depth domain.

4. The method of claim 3, wherein transforming the set of sequential measurement signals along the depth domain into the set of pseudo measurement signals along the depth domain and transforming the set of pseudo physical properties into the set of physical properties having continuation along the depth domain include utilizing B-spline functions, Gaussian functions, or F functions.

5. The method of claim 1, wherein the set of physical properties can be utilized to determine different facies of the subsurface region through which the borehole has traversed.

6. The method of claim 1, wherein the set of sequential measurements signals include NMR signals.

7. The method of claim 6, wherein the NMR signals are induced by application of a set of RF pulses.

8. The method of claim 6, wherein the NMR signals include multiple echo trains induced by applying a set of CPMG pulse sequences.

9. The method of claim 6, wherein the global inversion of the NMR signals are used to generate T₂ distributions, diffusion-T₂ 2D distribution, T₁-T₂ 2D distribution, and/or T₁-T₂-diffusion 3D NMR distributions.

10. A system configured to process subsurface logs to enhance the continuity of physical property measurements, the system comprising:
one or more processors, the one or more processors providing a correlation between depositionally equivalent subsurface events between separate litho facies by:
(a) obtaining a set of sequential measurement signals along at least one of a spatial or time domain from at least one sensor tool; the set of sequential measurement signals being obtained while the sensor tool moves through a borehole which has traversed through a subsurface region; and
(b) performing a global inversion of the set of sequential measurement signals along at least one of the spatial or time domain to determine a set of physical properties of the subsurface region having a smooth variation along at least one of the spatial or time domain, wherein the set of physical properties can be utilized to determine characteristics of the subsurface region.
